(19) United States
(12) Patent Application Publication
(10) Pub. No.: US 2018/0197423 A1
(43) Pub. Date: Jul. 12, 2018

(54) EDUCATION MODEL UTILIZING A QR-CODE SMART BOOK

(71) Applicant: AMERICAN NATIONAL ELT YAYINCILIK EGTIM VE DANISMANLIK LTD. STI., Antalya (TR)

(72) Inventor: Halil ÇIL, Antalya (TR)

(73) Assignee: AMERICAN NATIONAL ELT YAYINCILIK EGTIM VE DANISMANLIK LTD. STI., Antalya (TR)

(21) Appl. No.: 15/404,698

(22) Filed: Jan. 12, 2017

(51) Int. Cl. G09B 5/06; G06K 7/14

(52) U.S. Cl. CPC G09B 5/065; G06K 7/1417

(57) ABSTRACT

An education model utilizing a QR-code smart book used in Information Technologies/Technology/Education field.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to an education model utilizing a QR-code smart book used in the information technologies, technology and education fields.

### 2. Description of Related Art Including Information Disclosed Under 37 CFR 1.97 and 37 CFR 1.98

Today, digital education content (videos, audio, photographs/images, texts, mobile applications, computer programs and/or games designed therefor) in any defined field of education (such as mathematics, physics, vocational education, etc.) are prepared in whole or in part as printed media (textbooks, catalogues, exercise books, etc.). Even though there are hundreds of courses that prepare individuals for examinations in our country, regular attendance to courses may not be possible sometimes due to price and time. Sometimes, interaction with only textbooks may not be adequate. Furthermore, effective use of time is of utmost importance in today's conditions with the ever-increasing population. Accessing private teaching institutions such as education centers or courses present certain challenges. The present invention eliminates such problems.

### OBJECT OF THE INVENTION

The smart books and applications that are the subject of the invention and manufactured by the applicant bring the classroom environment to people offering them a model of education through which they can access education whenever and for however long they want.

### BRIEF SUMMARY OF THE INVENTION

The present invention is an education model utilizing a QR-code smart book used in information technologies, technology and education fields, the model including preparation of course slides, studio shots in a studio environment using the prepared course slides, a montage of the studio shots, conversion of videos in a book format and timing, QR codes, and presentation to the user through an application that the user can download to his or her mobile phone or tablet. The user scans the QR codes for operation.

In the present intention, a QR code that is automatically created on the specialized area under the course slides in the application enables the user timing by choosing the related seconds/periods of the course slides as a smart book.

### BRIEF DESCRIPTION OF THE SEVERAL VIEWS OF THE DRAWINGS

FIG. 1 is a system diagram.

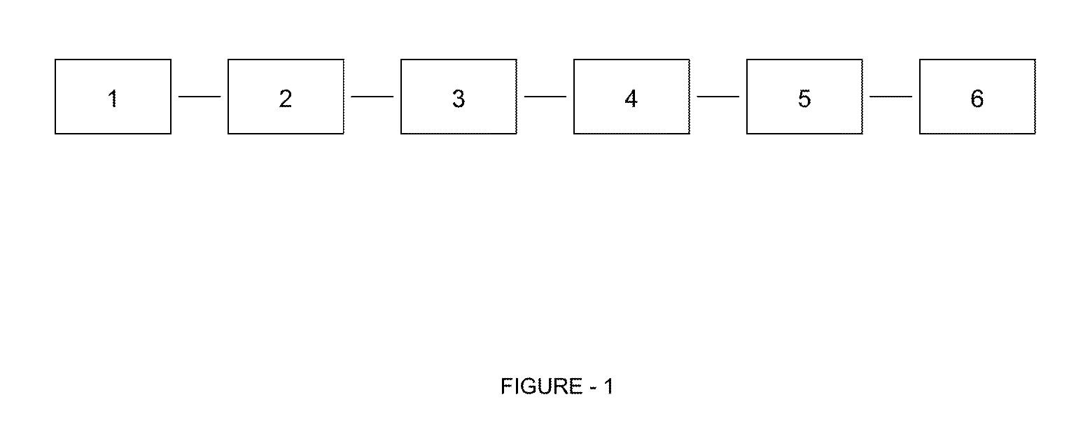

FIG. 2 illustrates the QR code location in the present invention.

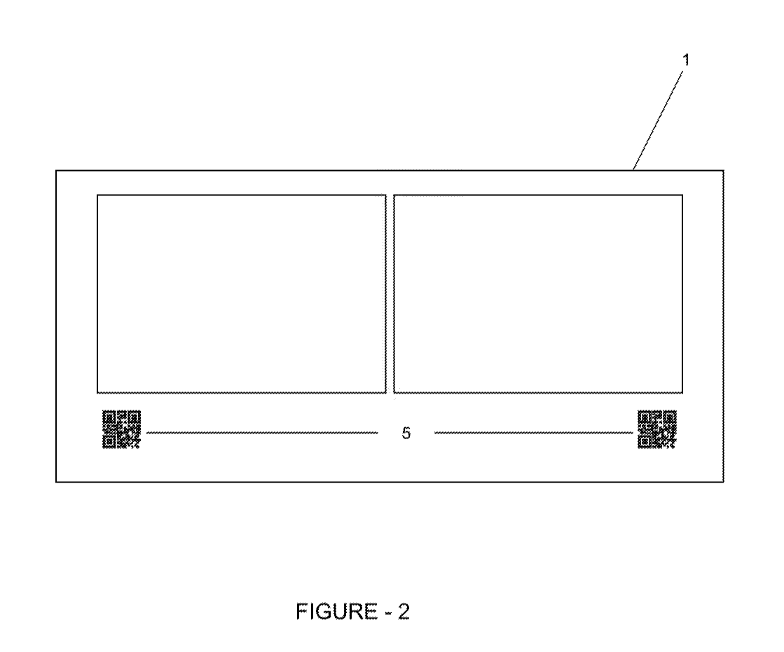

### NAMES REFERRED TO IN THE FIGURES

1—Course slides
2—Studio shots
3—Montage
4—Conversion of videos into a book format and timing
5—QR code
6—Application
7—User

### DETAILED DESCRIPTION OF THE INVENTION

The present invention relates to an education model utilizing a QR-code smart book used in Information information technologies, technology and education fields.

It is characterized by preparation of course slides (1), studio shots (2) in a studio environment using the course slides (1) prepared, a montage (3) of the studio shots (2), conversion of videos in a book format and timing (4), one or more QR codes (5), presentation to the user (7) through an application (6) that the user (7) can download to his or her mobile phone or tablet, and scanning of the QR Codes (5) by the user (7) for operation.

The QR codes (5) are automatically created on the specialized area under the course slides in the application (6). By this way, the user (7) can watch the chosen video course slides (1). The user (7) can watch the desired part of parts of the video instead of watching the whole one by timing.

The smart books that are the subject of the present invention and manufactured by the applicant bring the classroom environment to people offering them a model of education through which they can access education whenever and for however long they want.

The present invention, which is an education model utilizing a QR-code smart book used in the information technologies, technology and education fields brings the private teaching class environment to people without going to the private teaching class. Therefore, it is attractive since it is nested with technology in contrast to conventional books and helps develop interest in courses.

Moreover, people can use the invention whenever they want, at the times they determine and for the time periods they prefer at any place that has internet access, providing them convenience and time savings. Additionally, thanks to the videos created with the slides, the user who wants to study a specific topic is immediately directed to the slide of such topic without having to watch the videos of other topics in the beginning and at the end, which makes the invention very practical.

Education provided to people with visual aid is more effective.

It is possible to watch the videos by decreasing the video quality thanks to the option to choose from available resolutions as a measure against slow opening of high-resolution videos in environments where the internet connection speed is slow due to the existing infrastructure in our country.

The invention has a number advantages.
There is not a live programme or a face to face education
The videos are recorded in studios and after the videos are set, timing codes are recorded frame by frame. For example, in a Turkish lesson, the 1st unit can be watched on 3rd slide at 14th minute 52nd second (like a book page; 1st chapter, page number-number of the paragraph). So, when the QR code has been read, the student can reach the 14th minute 52nd second of the slide (as an example) and watch the desired video online. The student does not have to watch all of the videos.
The videos/montages and QR codes are stored in the application specialized for this education method and that can be loaded on mobile phones, tablets, PCs.

1. An education model utilizing a QR-code smart book comprising: preparation of course slides, studio shots in a studio environment using the course slides prepared, montage of the studio shots, conversion of videos in a book format and timing, QR code, presentation to the user through an application that the user can download to his or her mobile phone or tablet, and scanning of the QR Codes by the user for operation.

2. The education model of claim 1, further comprising a QR code that is automatically created on the specialized area under the course slides in the application that enables the user timing by choosing the related seconds/periods of the course slides as a smart book.
